(19) United States
(12) Patent Application Publication
(10) Pub. No.: US 2015/0320637 A1
(43) Pub. Date: Nov. 12, 2015

(54) WEARABLE PRESSURE POINT SYSTEM

(71) Applicant: David Marc Henre, Fort Collins, CO (US)

(72) Inventor: David Marc Henre, Fort Collins, CO (US)

(21) Appl. No.: 14/624,537

(22) Filed: Feb. 17, 2015

Related U.S. Application Data
(60) Provisional application No. 61/989,375, filed on May 6, 2014.

(51) Int. Cl. A61H 39/04; A61H 15/00; A61H 11/00

(52) U.S. Cl. CPC A61H 39/04; A61H 11/00; A61H 15/00; A61H 2201/0119; A61H 2205/065; A61H 2205/106; A61H 2205/108; A61H 2205/12; A61H 2205/102; A61H 2205/08; A61H 2205/02; A61H 2205/062

(57) ABSTRACT

Devices and method are disclosed for a wearable pressure point system for relieving pain, injury and tightness by applying pressure to specific tendons, ligaments, fascia, muscles and muscle groups. Devices comprise a compression system, including for example, a wearable harness, clamps, wraps and combinations thereof.

### CROSS-REFERENCE TO RELATED APPLICATION

This application claims the benefit of U.S. Provisional Patent Application No. 61/989,375 filed May 6, 2014, which is incorporated by reference in its entirety herewith.

### BACKGROUND

People often experience tightness, pain, injury, and loss of mobility in their muscles and joints. Conventionally, massage has been successful in providing some relief but self-massage is difficult, if not impossible, depending on where the pain and injury occurs.

Although braces have been developed to assist in relieving pain, injury, and tightness, such devices fail to stimulate specific muscles, muscle groups, fascia, tendons, ligaments or other tissues with appropriate pressure with unrestricted motion when worn. Therefore, what is needed is a device that relieves pain, injury, and tightness for a user, while also allowing the user to move and stretch unrestricted in any direction needed to obtain relief in the affected joint or muscle.

### SUMMARY

Disclosed are systems, devices and methods for directing pressure at specific points in muscle and tendons while a user is stationary or exercising. Such devices comprise a compression system, including, for example, a wearable harness, clamp, and other combinations thereof that are configured to place pressure on muscles, muscle groups, fascia, tendons, ligaments, or other tissue. By directing force toward a specific muscle, muscle group, fascia, tendon, ligament or other tissue, users can reduce pain and tightness in tissue as well as increase mobility in nearby joints. In certain embodiments, the compression system comprises a compression harness or a compression clamp, et alia, having a proximal end and a distal end, comprising a plurality of pressure point devices that are positioned between the proximal end and the distal end of the device. In certain embodiments, the compression system is a clamp placed on a limb, hands, feet, or other part of the body to compress pressure points on muscles, muscle groups, fascia, tendons, ligaments, or other tissue. In other embodiments, a system comprises a compression wrap configured to compress pressure points on muscles, muscle groups, fascia, tendons, ligaments, or other tissue. In certain embodiments, the system is removable allowing the device to be worn during exercise or at rest. Methods of using such devices are also disclosed and include physical rehabilitation, exercise, stretching, increasing joint mobility, and pain relief among others.

### BRIEF DESCRIPTION OF THE FIGURES

Having thus described the invention in general terms, reference is now made to the accompanying figures, which show different views of different example embodiments.

FIG. 1A is a view of an exemplary pressure point system comprising a “U” shaped prong clamp with a plurality of pressure point devices at terminal ends of the bar.

FIG. 1B is a view of an exemplary pressure point system if FIG. 1A, supra, wherein a pressure point device is axially rotated 180° about the bar to present at least one flat or curved surface opposite from other pressure point devices.

FIG. 2A is a view of an exemplary pressure point system comprising a “C” shaped prong clamp with a plurality of pressure point devices at terminal ends of the bar as well as a pressure point device located midway between the terminal ends.

FIG. 2B is a view of the exemplary pressure point system of FIG. 2A, supra, wherein a pressure point device is located midway between the terminal ends of the prongs and is axially rotated 180° about the bar.

FIG. 2C is a view of the exemplary pressure point system of FIG. 2B, supra, wherein the pressure point devices are cylindrical.

FIG. 3A is a view of an exemplary harness comprising an elastic compression system and multiple pressure point devices.

FIG. 3B is an exemplary view of a user wearing embodiments of the pressure point systems at exemplary sites of bodily attachment.

### DETAILED DESCRIPTION

Disclosed herein are systems, devices, and methods that may be used for physical rehabilitation, exercise, stretching, increasing joint mobility, and pain relief for example. The disclosed systems comprise compression systems to apply pressure to muscles, tendons, ligaments, etc. at pressure points on the body. As used herein, the term “compression system” refers a mechanism that creates compression via pressure point devices contacting a body part, such as hands, wrists, elbows, arms, lower arms, upper arms, legs, thighs, lower legs, feet, ankles, knees, a trunk, a neck, a head, a shoulder, et alia. Without being limited to any particular configuration, the compression system can comprise a bar, a clamp, elastic bands, harness, wraps, tape, or other similar system, as well as combinations of the same. In one example, the compression system comprises a single “U” shaped or “C” shaped curved metal bar acting as a clamp with prongs that is resistant to deformation. In another example, the compression system is an elastic wrap which creates compression. In yet another example, a compression system comprises counter-opposing levers under elastic tension, as in a spring resistance clothespin type configuration.

A pressure point device is used in combination with the disclosed compression systems to create pressure specific pressure points on muscles, muscle groups, fascia, tendons, ligaments, or other tissue and combinations thereof under compression. A “pressure point device” is defined as any object that applies pressure to a specific body part such as, for example, muscles, muscle groups, fascia, tendons, ligaments, or other tissue when under compression against the body part. As detailed further herein, a pressure point device can be any object which places pressure to a specific area of the body including, but not limited to balls, spheres, cones, wedges, hemispheres, semi-hemispheres, cylinders placed laterally or perpendicularly, rollers, plates, prongs, rings, oval shapes, octagonal shapes, other shapes and combinations thereof. Pressure point devices may be elastomeric or non-elastomeric. Elastomers can be deformable or non-deformable depending on the desired result.

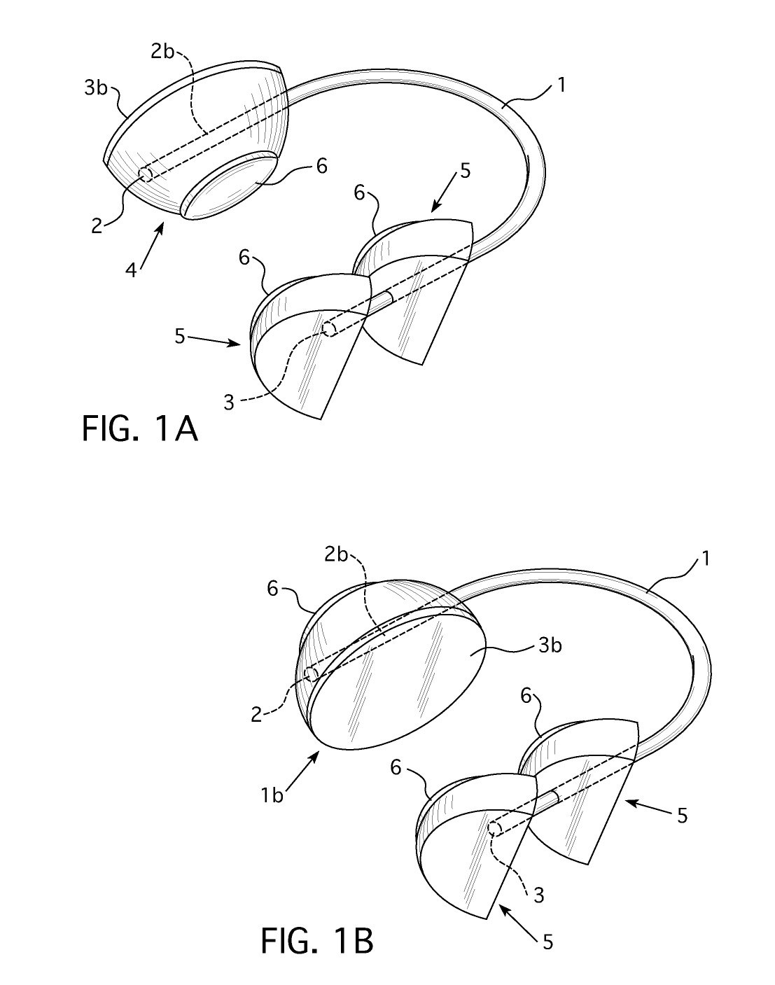

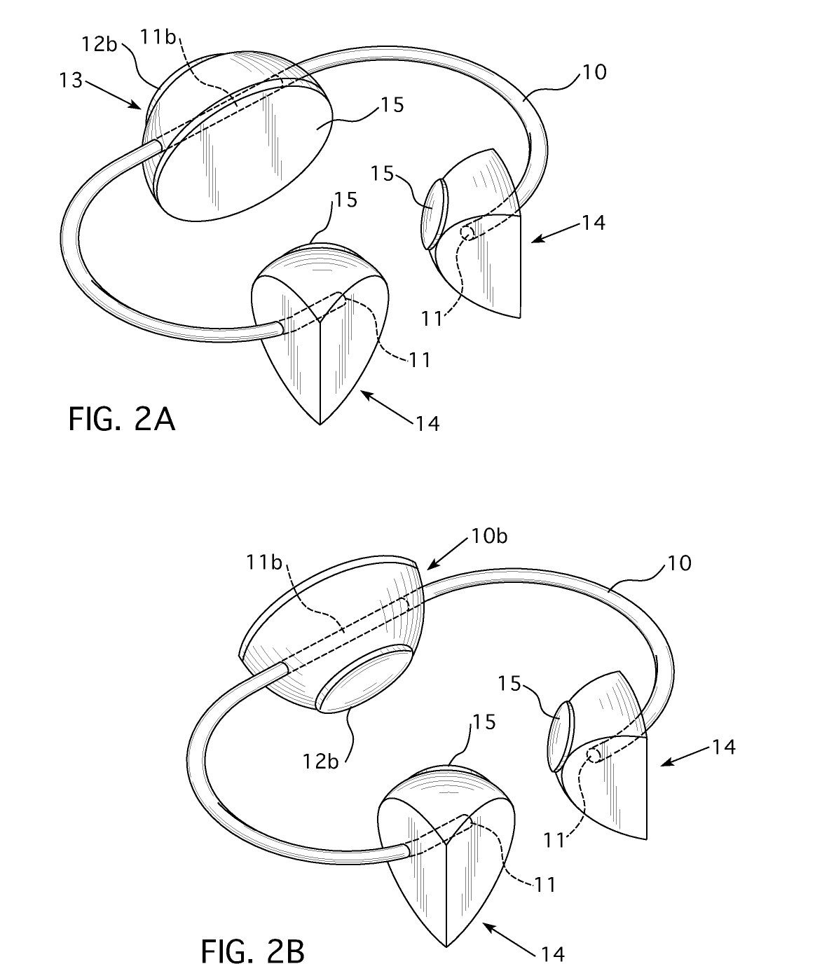

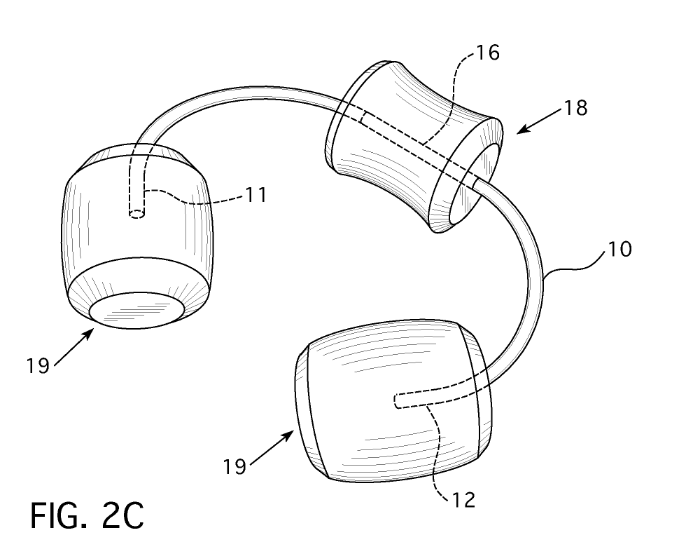

While it is not necessary for a pressure point device to be permanently affixed to a compression system, certain additional advantages arise from affixing pressure point devices to a compression system at positions which advantageously apply pressure at or near sites of injury, tightness, and pain. Indeed, it is contemplated that in certain embodiments, the compression system is compositional integrated with pressure point devices, as in for example a molded monolithic clamp having pressure point devices integrally molded into the clamp. In some other embodiments, pressure point devices and the compression clamp are pre-formed together in a single mold. In yet other embodiments, the pressure point devices and the compression systems are molded separately and then attached to each other. Alternatively, pressure point devices may be connected to the compression system using any means known in the art including welding, gluing, casting, molding, tying, bolting or any other means. In any of the solid-body examples of the disclosure, including for example the disclosed exemplary embodiments of FIG. 1A, FIG. 1B, FIG. 2A, and FIG. 2B, the combined compression system and pressure point devices may be used as a positive cast for molding a subsequent integrated monolithic device. Pressure point devices can be padded for contact with a body surface. Any surface may also comprise hook-loop fasteners, ripples, bumps, knobs, waves, grit, or roughened surfaces, for example.

The composition of pressure point devices is not limited to any particular materials, but include metal, wood, cork, elastomers, plastic, rubber, foam, fiberglass, carbon fiber, ceramics, resins, and combinations of these for example. In certain embodiments, the density of exemplary materials of foam range from 0.8-2.5 pounds per cubic foot. In certain embodiments, rubber is used at a density of 57-74 pounds per cubic foot, and specifically includes soft rubber at about 57 pounds per cubic foot, intermediate density rubber of 69 pounds per cubic foot, and hard rubber at 74 pounds per cubic foot. Where elastomers are used in pressure point devices, synthetic rubber, natural vulcanized rubber, plastics, foams, and combinations thereof may be used, for example.

When a compression system comprises a clamp, any material sufficient to create compression may be used. Metal such as curved aluminum and steel bars and pipes are suitable. Similarly, large diameter prongs similar in design to clothes pegs with a slot may be used. The composition of a curved bar clamp is not limited to any particular materials but may include metal, wood, plastic, PVC pipe, fiberglass, foam, carbon fiber, ceramics, resins, and combinations of these, for example. Metals are particularly advantageous in certain embodiments, and include, but are not limited to, aluminum, titanium, copper, steel, iron, tin, other metals, and alloys thereof. Where a clamp is used on a body part, a curved steel bar has a higher resistance to deformation creating a tighter clamping force; whereas a curved aluminum bar is more flexible and creates a relatively less tight clamping force.

In certain embodiments, materials for a clamp can be shaped as a curved rod or a curved pipe. Straight metal bars can be curved into a desired shape by means known in the art including used of a wire or tube bending apparatus. In certain embodiments where the bar or pipe is plastic or carbon fiber, a curved shape can be obtained by casting, heating, or molding such materials to a desired curved shape. The curvature of a bar clamp can be any angle sufficient to create compression on a body part. For example, a clamp may comprise a 90° bend or greater. In other embodiments, a clamp may comprise a 180° bend or greater. In certain specific embodiments, a clamp may comprise one or more bends at angles of about 90°, 100°, 110°, 120°, 130°, 140°, 150°, 160°, 170°, 180°, 190°, 200°, 210°, 220°, 230°, 240°, 250°, 260°, 270°, 280°, 290°, 300°, 310°, 320°, 330°, and combinations thereof. For example, a bar may comprise two 90° bend angles to create an 180° bend. It is contemplated that the clamp could form a complete 360° ring or partial ring that may slide onto a body part such as a limb. Indeed, in certain embodiments, the ring may form a spiral around a center point where a body part such as a limb may be inserted.

Exemplary embodiments of the disclosed devices include the device shown in FIG. 1A. Specifically, a “U” shaped curved bar 1 forms a compression system capable of clamping onto a limb or other body part. The curved bar comprises at least two terminal ends 2 and 3, where an at least one pressure point devices is affixed at a first end 4 and an at least one, but optionally a plurality, of devices 5, are affixed to a second end. When the curved bar comprising pressure point devices is clamped on a limb for example, the curved bar resists deformation thereby applying pressure at specific, opposing points on the limb. Optionally, padding 6 may be added to any surface that contacts a body part. The pressure point devices can be threaded onto the bar 1 or otherwise affixed. In FIG. 1A the exemplary pressure point device's composition is sufficiently dense so a compression joint 7 forms when a terminal end of a bar is inserted into a receiving collar drilled into the pressure point device. A pressure point device may rotate axially about the compression joint or in certain other embodiments, a compression joint can be reinforced with glue, for example, and thereby prevent the pressure point device from rotating axially around the joint. In FIG. 1A, the exemplary pressure point devices 4 and 5 comprise dense rubber or plastic balls sectioned into halves and quarters, respectively. Halving a ball creates a hemisphere 4 with a single flat surface 8 thereby resulting in a hemispherical pressure point. Quartering a ball creates a semi-hemisphere 5 having two flat surfaces.

FIG. 1B shows the device of FIG. 1A, supra, wherein a pressure point device 4 at a first end of a curved bar 1 is optionally rotated 180° axially about the bar presenting a flat surface 8 of the hemisphere toward the interior of the device and thereby towards a body part when in use. Optional axial rotation of a pressure point device is an advantageous in situations where asymmetric stimulation of a muscle group is desired such as the lower leg, the hand, or other body part. For example, because the calf is situated opposite shin, the disclosed embodiment can be clamped onto the shin and the calf so that the axially rotated hemisphere 4 creates at least one substantially flat, non-painful, contact surface at the shin bone, but the other pressure point devices 5 are still directed in towards the calf. Indeed, in certain embodiments, where compression asymmetry is desired, the contact surface at a bone or other potentially painful surface can be formed into a curve or molded to the shape a body part at the contact surface. In such embodiments, the objective is to maintain enough pressure to provide pressure point stimulation for at least one other contact surface while reducing the pressure placed on potentially painful opposing body surfaces simultaneously under compression. In some embodiments, the pressure point device is a plate which reduces the specific point pressure at one body part surface by contact a larger body part surface, while maintaining higher specific point pressure at other body surfaces oppositional to any particular pressure point device. Thereby, specific bodily pressure points can be stimulated under compression, while distributing pressure on potentially painful body surfaces under oppositional compression.

In certain embodiments, additional padding including padding gels can be placed on the device contacting surface potentially painful body parts such as bone. Thus, padding can also be used to increase comfort at one compression point while preserving the benefits of point pressure at oppositional points under compression.

Shown in FIG. 2A. is another exemplary embodiment. Specifically, a “C” shaped curved bar 10 also forms a compression system capable of clamping onto a limb or other body part. As shown, the curved bar comprises at least two terminal ends 11 and 12 and where an at least one pressure point devices 13 is affixed at the central portion of the bar, but optionally a plurality of devices 14, are also affixed to terminal ends of the bar. Optionally, padding 15 may be added to any surface that contacts a body part. The composition of the pressure point devices is sufficiently dense so that a compression joint 16 is formed when the bar is inserted into a receiving collar drilled inside the device either fully or partially. When clamped on a limb for example, the curved bar resists deformation thereby applying bodily point pressure from the device at three specific points on the limb. The exemplary pressure point devices 13 and 14 in FIG. 2A comprise dense rubber or plastic balls sectioned into halves 13 resulting in hemispheres having one flat surface 17 and quarters 14 resulting in semi-hemispheres.

In certain embodiments as shown in FIG. 2B, a pressure point device 13 at a central portion of a curved bar may be rotated axially about the bar. The diameter of the collar is smaller than the diameter of the bar such that the diameter of the bar forms a compression joint 16 inside the collar. In certain other embodiments the compression joint is reinforced with glue and thereby prevented from rotating axially. Individual axial rotation of a pressure point device is an advantageous option in situations where asymmetric stimulation of a muscle group is desired such as the lower leg, the hand, or other body part.

Shown in FIG. 2C. is another exemplary embodiment. Specifically, a “C” shaped curve as in FIG. 1 comprises a bar 10 that also forms a compression system capable of clamping onto a limb or other body part. As shown, the curved bar comprises at least two terminal ends 11 and 12 and where an at least one pressure point devices 18 is affixed at the central portion of the bar, but optionally a plurality of devices 19, are also affixed to terminal ends of the bar. Optionally, padding may be added to any surface that contacts a body part. The composition of the pressure point devices is sufficiently dense so that a compression joint 16 is formed when the bar is inserted into a receiving collar drilled inside the device either fully or partially. When clamped on a limb for example, the curved bar resists deformation thereby applying point pressure from the device at three specific points on the limb. The exemplary pressure point devices 18 and 19 in FIG. 2C comprise foam cylinders. The foam cylinder 18 at the central portion of the bar is inwardly curved to provide comfort when placed against bone, such as the shin. The foam cylinders at the terminal ends are outwardly curved to apply more concentrated pressure on tissue under compression.

In certain embodiments as shown in FIG. 2C, a pressure point device 18 at a central portion of a curved bar may be rotated axially about the bar. The diameter of the collar is smaller than the diameter of the bar such that the diameter of the bar forms a compression joint 16 inside the collar. In certain other embodiments the compression joint is reinforced with glue and thereby prevented from rotating axially. Individual axial rotation of a pressure point device is an advantageous option in situations where asymmetric stimulation of a muscle group is desired such as the lower leg, the hand, or other body part.

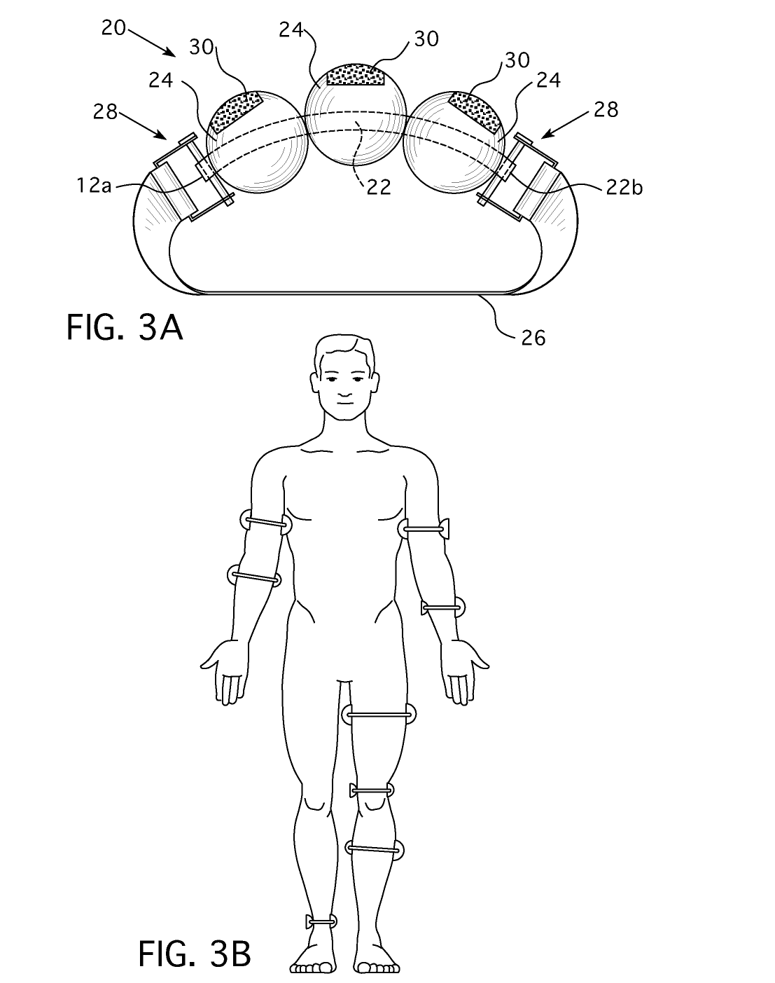

In embodiments as shown in FIG. 3A, the compression system comprises a harness 20 having a curved support 22 that may be a substantially cylindrical, curved material, such as a pipe or a rod. For example, the curved support 22 may comprise a steel rod, aluminum bar or a polyvinylchloride (PVC) pipe. The degree of the curve of the curved support 22 may be dependent on the size of the area of the body to which a user intends to attach the harness 20. In some embodiments, the curved support 22 may be curved to a soft about 90° bend. The curved support 22 may have any suitable diameter and length to accommodate a plurality of pressure point devices and, in some embodiments, may be balls or cylinders having a diameter of about ½ inch and a length of about 8.5 inches.

For example, the curved support 22 may have a length suitable to accommodate a plurality of balls 24, such as from about 2 to about 4 balls, such as 3 balls. The balls 24 may comprise a collar drilled through the approximate center thereof, wherein the collar has a diameter sufficient to accommodate the curved support 22. The plurality of balls 24 may be threaded onto the curved support 22 using a compression joint formed by drilling a receiving collar through each of the balls. The balls 24 may have any suitable shape and, in some embodiments, have a substantially circular shape with a smooth outer surface. Alternatively, the balls 24 may be ovular, football-shaped, triangular, square, rectangular, or any other desired shape. Additionally, the balls 24 may have a non-smooth outer surface, such as an outer surface comprising bumps, knobs, ridges, ribs, or the like. Embodiments of the balls 24 may have any size suitable to accommodate the curved support 22. For example, the balls 24 may have a diameter of about 3 inches. The balls 24 may be made of any suitable material, such as rubber, plastic, or foam. In some embodiments, the wearable harness may also comprise a variety of other objects positioned along the curved support, such as hard rubber rings, oval shapes, octagonal shapes, and any other desired items.

As described above, the proximal end 25 and the distal end 26 of the curved support 22 may be connected by a elastic band such as a strap 27, wherein the strap 27 may be configured to attach the wearable harness 20 to a user's body. The strap 27 may attach to each of the proximal end 25 and the distal end 26 using any suitable means, such as conventional fasteners. In some embodiments, the strap 27 may be attached to each of the proximal end 25 and the distal end 26 using a buckle 28, such as a snap pin and buckle. Thus, each of the proximal end 25 and the distal end 26 may comprise a linking collar, the linking collar having a size sufficient to accommodate the snap pin therein. Moreover, in some embodiments, each of the proximal end 25 and the distal end 26 may further comprise a swivel to increase balance when in use. For example, the orifice may have a diameter of about 2¼ inches, and the snap pin may have a diameter of about 2¼ inches and a length of about 3 inches. The strap 27 may have any length sufficient to allow the harness 20 to be attached to an area of a person's body. For example, in some embodiments, the strap 27 may have a length of about 3 feet. The strap 27 may also be made of any suitable material and, in some embodiments, comprises a hook and loop fastener, such as Velcro, having a width of about 2 inches. When the strap 27 comprises a hook and loop fastener, the harness 20 may be adjustable to fit a large number of different sized body parts. In some embodiments, the plurality of balls 24 may each have a fastener 28 attached thereto, the fastener being configured to engage with the strap 26. For example, in some embodiments, the balls 24 may each comprise a hook and loop fastener adhered or otherwise attached thereto, wherein the strap 27 is configured to engage with the hook and loop fastener. Alternatively, the balls may comprise any other conventional fastener, such as a button, snap, clip, or the like, wherein the fastener 30 is configured to engage with the strap 27.

Some embodiments of the wearable harness may further comprise a cover configured to enclose the curved support, plurality of balls, and buckles. For example, the cover may comprise a neoprene band. Alternatively, the cover may comprise any other conventional material.

As exemplified in FIG. 3B, the user may attach the pressure point system to any suitable points on the body, such as limbs, forearms, upper arms, lower legs, thighs, hands, feet, the trunk, neck, hips, gluteal muscles, shoulders or other body part including those above, below or aside any particular joint. When the user needs to stretch the front or the back of a limb, the user will position the pressure point devices accordingly. The user may then tighten a strap or compress a clamp until the pressure point devices press into the tissue. The pressure point devices may pin the tissue, while also allowing space for blood to flow in the limb. A strap or clamp may be tightened to pin the tissue. Then, the user may slowly stand up and stretch. If no stretching of the joint or tissue is felt, the user may adjust the compression accordingly. Once a user feels appropriate pressure on the tissue, the user can walk, move around, as well as move their arms in circles while rotating the hands and wrists, for example. The device may be left on for a period of time suiting the user. The stretching may be repeated as often as necessary or as desired. The free movement of the body part creates variable resistance and compression for the user as muscle groups and tendons move under, against, or alongside the pressure point devices. Indeed, unlike having a brace, user movement is not restricted, although the disclosed systems may be used with a brace.

For certain embodiments, the devices and methods are useful in yoga, Pilates, tai chi, weight lifting, rehabilitation, physical therapy, acupressure, cross-fitness and martial arts stances and forms, as well as any other exercise. For example, the systems described are also useful for body building, rehabilitation of balance, rehabilitation for pain and cramping as well as for muscular atrophy, and recovery from high intensity exercise such as running, marathons, and bicycling. For youths, the device is highly entertaining and can be used as an entertainment device alone or incorporated into children's gym activities. Similarly, the device is useful in training for skiing, surfing, dancing, gymnastics, skating, skateboarding and obstacle courses as well as such sports as soccer, baseball, football, and wrestling among others. In certain embodiments, the systems are used for in-place running and jumping exercises.

### Example 1

A U-shaped compression device was formed from ¼ inch aluminum bar bent at approximately 180° similar to FIG. 1. The aluminum bar was 8 inches long. At the first terminal end of the bar a solid rubber hemispherical pressure point device was threaded onto the bar. The pressure point device was manufactured by cutting a lacrosse ball having a 20 inch diameter in half and drilling a ¼ inch receiving collar into the ball, which formed a compression joint holding the pressure point device in place, while allowing it to rotate axially about the bar. Similarly, a lacrosse ball was cut into quarters to form semi-hemispheres and drilled with receiving collars to create the pressure point devices that were then threaded onto the other terminal end of the aluminum bar. These dual pressure point devices were threaded onto the bar side by side. The distance between the opposing dual pressure point devices and the hemisphere was approximately 1¼ inches. Plastic pads were adhered to the body contact surfaces of the pressure point devices.

The pressure point system was particularly suitable to attach to the forearm. However, the distance between the opposing dual pressure point systems can be scaled to any distance by increasing the length of the bar, decreasing the circumference of the pressure point device ball, rotating the pressure point devices axially, changing the bend angle, or any combination thereof. A smaller version was made for use on the hands and feet.

### Example 2

A C-shaped compression device was formed from ¼ inch aluminum bar bent at approximately 330° similar to FIGS. 2A, 2B, and 2C. The aluminum bar was 16 inches long. At the center of the bar, a solid rubber hemispherical pressure point device was threaded onto the bar. The pressure point device in FIG. 2A was manufactured by cutting a solid rubber lacrosse ball having a 20 inch diameter in half and drilling a ¼ inch receiving collar into the ball, thereby forming a compression joint that held the pressure point device in place, while allowing it to rotate axially about the bar at the user's convenience. Similarly, a lacrosse ball was cut into quarters to form semi-hemispheres and drilled with receiving collars to create the pressure point devices that were then threaded onto each of the two terminal ends of the aluminum bar. The distance between the opposing semi-hemispheres and the hemisphere was approximately 2½ inches. Neoprene rubber pads were adhered to the body contact surfaces of the pressure point devices. The pressure point devices in FIG. 2C are cylindrical foam rollers at the terminal ends of the bar. The pressure point device in the central portion of the bar is a foam cylinder with an inwardly curved roller, designed to be placed against a bone, such as the shin.

The pressure system was particularly suitable to attach to the calf and biceps/triceps muscle group. However, the distance between the opposing dual pressure point systems can be scaled to any distance by increasing the length of the bar, decreasing the circumference of the pressure point device ball, rotating the pressure point devices axially, changing the bend angle, or any combination thereof. A larger version was also made for the thigh.

Actual users of these systems, devices, and methods have reported therapeutic benefits from use. For example, a dentist has used the disclosed devices on his forearm to abate the symptoms of occupational tendonitis. A bicycle enthusiast has used the disclosed devices to help her with plantar fasciitis and low back pain. A Yoga instructor has used the disclosed devices to help her increase her stretch and improve balance in her poses. A tennis pro has used the disclosed devices to remediate his tennis elbow and plantar fasciitis as well as alleviate knee and low back pain. A professional mogul skier has used the disclosed devices help alleviate with knee and low back pain. A professional Ashiatsu massage therapist has used the disclosed devices to prevent pain in her lower legs. A local city employee has eliminated his plantar fasciitis using the disclosed devices. A florist has used the disclosed devices to alleviate and manage the pain in her hands from repetitive stress motion. A collegiate high jumper has used the disclosed devices assist in her recover from knee surgery. A teacher has used the disclosed devices to alleviate and manage occupationally induced pain and tension in her neck and shoulders.

Other modifications and embodiments of the invention will come to mind in one skilled in the art to which this invention pertains having the benefit of the teachings presented herein. Therefore, it is to be understood that the invention is not to be limited to the specific embodiments disclosed. Although specific terms are employed, they are used in generic and descriptive sense only and not for purposes of limitation, and that modifications and embodiments are intended to be included within the scope of the appended claims.

What is claimed is:

1. A wearable pressure point system comprising a compression system that directs force from an at least one pressure point device connected to the compression system to a body part in contact with the pressure point device.

2. The system of claim 1, wherein padding is affixed to a surface of the pressure point where the pressure point device is in contact with a body part.

3. The system of claim 1, wherein the compression system comprises a curved bar comprising a proximal end and a distal end; a plurality of balls positioned on the curved support between the proximal end and the distal end; and a strap attached to the proximal end and the distal end, the strap configured to removably attach the system to a user's body.

4. The system of claim 1, wherein the compression system comprises a compression wrap; a plurality of hemispheres having a flat and a curved side under the compression wrap wherein the flat side of a hemisphere is attached to the compression wrap; and the wrap configured to removably attach the system to a user's body.

5. The system of claim 4, wherein the compression wrap is an elastomer.

6. The system of claim 1, wherein the compression system comprises a compression clamp wherein a plurality of pressure point devices are attached to an interior portion of the clamp; and the clamp is configured to removably attach the system to a user's body.

7. The system of claim 6, wherein the compression clamp and the pressure point devices are molded into a monolithic device.

8. A wearable pressure point system comprising a clamp compression system wherein the clamp comprises a bar curved at a bend angle of greater than 90° further wherein an at least one pressure point device is threaded onto the bar through a receiving collar inside the pressure point device thereby forming a compression joint affixing the pressure point device to the bar.

9. The system of claim 8, wherein the at least one pressure point device is selected from the group consisting of balls, spheres, cones, wedges, hemispheres, semi-hemispheres, cylinders, inwardly-curved cylinders, outwardly-curved cylinders, rollers, plates, prongs, rings, oval shapes, octagonal shapes, and combinations thereof.

10. The system of claim 9, wherein the at least one pressure point device is selected from the group consisting of spheres, hemispheres, and semi-hemispheres.

11. The system of claim 9, wherein the at least one pressure point device is composed of a material selected from the group consisting of metal, wood, cork, elastomers, plastic, rubber, foam, fiberglass, carbon fiber, ceramics, resins, and combinations thereof.

12. The system of claim 9, wherein the clamp is composed of a material consisting of metal, aluminum, titanium, copper, steel, iron, tin, alloys, wood, plastic, PVC pipe, fiberglass, foam, carbon fiber, ceramics, resins, and combinations thereof.

13. The system of claim 9, wherein the bend angle of the bar is selected from the group consisting of 90°, 100°, 110°, 120°, 130°, 140°, 150°, 160°, 170°, 180°, 190°, 200°, 210°, 220°, 230°, 240°, 250°, 260°, 270°, 280°, 290°, 300°, 310°, 320°, 330°, and combinations thereof.

14. The system of claim 13, wherein the bend angle is about 180°, thereby forming a “U” shaped clamp having two prongs and an at least two terminal ends on each prong.

15. The pressure point system of claim 14, further comprising a plurality of pressure point devices wherein a first pressure point device is a hemisphere solid threaded a first terminal end of the bar and an at least one second pressure point device comprising a semi-hemisphere solid threaded onto the terminal end of the second prong.

16. The system of claim 13, wherein the bend angle is about 330°, thereby forming a “C” shaped clamp having two prongs and an at least two terminal ends on each prong.

17. The system of claim 16, further comprising a plurality of pressure point devices wherein a first pressure point device is a hemisphere solid threaded onto the bar between the two prongs and an a second pressure point device comprising a semi-hemisphere solid threaded onto the terminal end of the first prong and a third pressure point device comprising a semi-hemisphere solid threaded onto the terminal end of the second prong.

18. A method of treating pain comprising, attaching to a body part a wearable pressure point system, comprising a clamp compression system wherein the clamp comprises a bar curved at a bend angle of greater than 90° further wherein an at least one pressure point device is threaded onto the bar through a receiving collar inside the pressure point device thereby forming a compression joint affixing the pressure point device to the bar.

19. The method of claim 18, wherein the body part is selected from the group consisting of hands, wrists, elbows, arms, lower arms, upper arms, legs, thighs, lower legs, feet, ankles, knees, a trunk, a neck, a head, a shoulder, and combinations thereof.

20. The method of claim 18, wherein the pain is caused by injury from the group selected from plantar fasciitis, carpel tunnel syndrome, and repetitive stress injury.
